(19) United States
(12) Patent Application Publication
(10) Pub. No.: US 2020/0052563 A1
(43) Pub. Date: Feb. 13, 2020

(54) MOTOR AND PUMP APPARATUS

(71) Applicant: NIDEC SANKYO CORPORATION, Nagano (JP)

(72) Inventors: Masaki HARADA, Nagano (JP); Hiroki KURATANI, Nagano (JP); Nobuki KOKUBO, Nagano (JP); Takashi YAMAMOTO, Nagano (JP)

(21) Appl. No.: 16/485,950

(22) PCT Filed: Feb. 7, 2018
(86) PCT No.: PCT/JP2018/004138

§ 371 Date: Aug. 14, 2019

(30) Foreign Application Priority Data
Feb. 14, 2017 (JP) 2017-024966

(51) Int. Cl. H02K 15/10; H02K 3/52; H02K 15/12

(52) U.S. Cl. CPC H02K 15/10; H02K 15/12; H02K 3/522

(57) ABSTRACT

A motor may include a rotor; a stator disposed on an outer peripheral side of the rotor; and a resin sealing member covering the stator. The stator may include a stator core; a coil wound around the stator core; and a connector disposed on an outer peripheral side of the stator core. The resin sealing member may include a connector sealing part protruding to the outer peripheral side of the stator core and covering the connector. The connector may include a connection opening through which an external connector is attached and detached, and the connection opening protrudes in an axial direction of the rotor from the connector sealing part and is opened in the direction of the axis.

### CROSS REFERENCE TO RELATED APPLICATIONS

This is the U.S. national stage of application No. PCT/JP2018/004138, filed on Feb. 7, 2018. Priority under 35 U.S.C. § 119(a) and 35 U.S.C. § 365(b) is claimed from Japanese Application No. 2017-024966, filed Feb. 14, 2017; the disclosures of which are incorporated herein by reference.

### TECHNICAL FIELD

At least an embodiment of the present invention relates to a pump apparatus and a motor used in the pump apparatus.

### BACKGROUND

Patent Literature 1 discloses a pump apparatus that rotates an impeller by using a motor. The motor used in the pump apparatus disclosed in Patent Literature 1 includes: a rotor; and a stator disposed on the outer peripheral side of the rotor, and the stator is covered and sealed with BMC resin. A case member (upper case) forming a pump chamber is screwed to a resin sealing member that covers the stator. The stator includes: a stator core; an insulator; and a conductive wire wound around the insulator. The conductive wire is connected to an external-connection connector through a substrate. In the connector, although a connection part with the substrate is covered with the resin sealing member, an external-connection terminal protrudes in a radial direction from the outer peripheral surface of the resin sealing member.

### PATENT LITERATURE

### [Patent Literature 1] Japanese Unexamined Patent Application Publication No. 2016-3580

In the motor disclosed in Patent Literature 1, as the external-connection terminal of the connector protrudes in the radial direction from the outer peripheral surface of the resin sealing member and is exposed to the outside, there is a possibility that water, or the like, is directly dropped on the external-connection terminal, and it is difficult to ensure waterproofness. Furthermore, as the connection terminal may be directly touched or an impact may be applied to the connection terminal, it is difficult to sufficiently protect the external-connection terminal.

### SUMMARY

In view of the above problem, at least an embodiment of the present invention, in a motor including a resin sealing member that covers a stator, improves the waterproofness of a connector to which a conductive wire is connected and protect the connector.

In order to solve the above problem, the motor according to at least an embodiment of the present invention includes: a rotor, a stator disposed on the outer peripheral side of the rotor; and a resin sealing member covering the stator, wherein the stator includes: a stator core, a coil wound around the stator core; and a connector disposed on an outer peripheral side of the stator core, the resin sealing member includes a connector sealing part protruding to the outer peripheral side of the stator core and covering the connector, and the connector includes a connection opening through which an external connector is attached and detached, and the connection opening protrudes in a direction of an axis of the rotor from the connector sealing part and is opened in the direction of the axis.

According to at least an embodiment of the present invention, the resin sealing member covering the stator includes the connector sealing part protruding to the outer peripheral side of the stator core and covering the connector. In this manner, as the resin sealing member is integrally formed, including not only the part covering the stator core and the coil but also the part covering the connector, the waterproofness and the impact resistance of the connector may be improved. Furthermore, even when the connection opening is opened in the direction of the axis, the waterproofness and the impact resistance of the connector may be enhanced.

According to at least an embodiment of the present invention, the resin sealing member includes a sealing member bottom part covering the stator core and the coil from a side of the direction of the axis, the connector sealing part protrudes in the direction of the axis from the sealing member bottom part, and a height, in the direction of the axis, of the connection opening from the sealing member bottom part is larger than a height of protrusion of the connector sealing part from the sealing member bottom part. In this manner, when a liquid such as water is dropped on the sealing member bottom part, there is little possibility that the liquid flows into the connection opening over the connector sealing part. Therefore, the waterproofness of the connector may be secured.

According to at least an embodiment of the present invention, it is possible to adopt a configuration in which a cover member disposed on one side of the resin sealing member in the direction of the axis is provided, wherein the connector includes a connector housing protruding from the connector sealing part to the other side in the direction of the axis, the connection opening being provided in the connector housing, and one of the resin sealing member and the cover member is provided with an engagement projection that protrudes toward the other one thereof, and the other one is provided with a rotational engagement part that is engaged with the engagement projection when the cover member is rotated relative to the resin sealing member around the axis. With this configuration, as the connector sealing part protrudes to the outer peripheral side, the resin sealing member may be supported with the connector sealing part as a fulcrum when the cover member and the resin sealing member are manually assembled.

Therefore, the workability for manually assembling the cover member and the resin sealing member is improved. Furthermore, as only the connection opening is exposed to the outside, assembly may be performed without directly touching terminal pins of the connector during manual assembly. Furthermore, as the connector sealing part protects the connector, the load applied to the connector is small when the connector sealing part is used as a fulcrum. Thus, the connector may be protected during assembly.

According to at least an embodiment of the present invention, the connector includes a terminal pin that is pressed and fitted into the connector housing. This attachment of the terminal pin by press fitting may prevent resin from entering the connector housing through the press-fitting hole when the connector sealing part is molded with resin. Thus, resin may be prevented from adhering to the terminal pin disposed in the connector housing.

According to at least an embodiment of the present invention, the terminal pin includes: a terminal connection part pressed and fitted into the connector housing and protruding toward the connection opening; a coupling part extending in a direction intersecting a direction in which the terminal connection part is pressed and fitted; and a conductive-wire connection part connected to the terminal connection part via the coupling part, and a holding groove for holding the coupling part is formed on an outer side surface of the connector housing. By thus holding the coupling part with the holding groove, it is possible to prevent the terminal pin from rotating around the terminal connection part. Therefore, the terminal pin may be prevented from rotating when the connector sealing part is molded. Further, the formation of the connector sealing part may prevent the terminal pin from coming off.

According to at least an embodiment of the present invention, the connector housing includes a bottom part provided on an opposite side of the connection opening in the direction of the axis, and a recess depressed in the direction of the axis is formed in the bottom part. This allows a depressed part (recess) to be provided in the connector housing, whereby the formability of the connector housing may be improved.

Further, the pump apparatus according to at least an embodiment of the present invention is characterized by including the above-described motor; and an impeller attached to a rotary shaft of the rotor penetrating the cover member and protruding to the one side of the cover member.

According to at least an embodiment of the present invention, the resin sealing member covering the stator is integrally formed, including not only the part covering the stator core and the coil but also the connector sealing part protruding to the outer peripheral side of the stator core and covering the connector, whereby the waterproofness and the impact resistance of the connector may be improved.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an external perspective view of a pump apparatus to which at least an embodiment of the present invention is applied.

FIG. 2A and FIG. 2B are a cross-sectional view of the pump apparatus and a partially enlarged view thereof.

FIG. 3 is an exploded perspective view of a motor when viewed from an output side.

FIG. 4 is an exploded perspective view of the motor when viewed from an opposite output side.

FIG. 5 is a perspective view of a stator when viewed from the opposite output side.

FIG. 6 is a perspective view of the stator when viewed from the output side.

FIG. 7 is an exploded cross-sectional view of the motor.

FIG. 8 is a plan view of a cover member when viewed from the opposite output side.

FIG. 9A and FIG. 9B is an enlarged cross-sectional view of an adhesive fixing part between a resin sealing-member side fixing surface and the cover member.

### DETAILED DESCRIPTION

An embodiment of a pump apparatus and a motor to which at least an embodiment of the present invention is applied is described below with reference to the drawings.

### (Overall Structure of the Pump Apparatus)

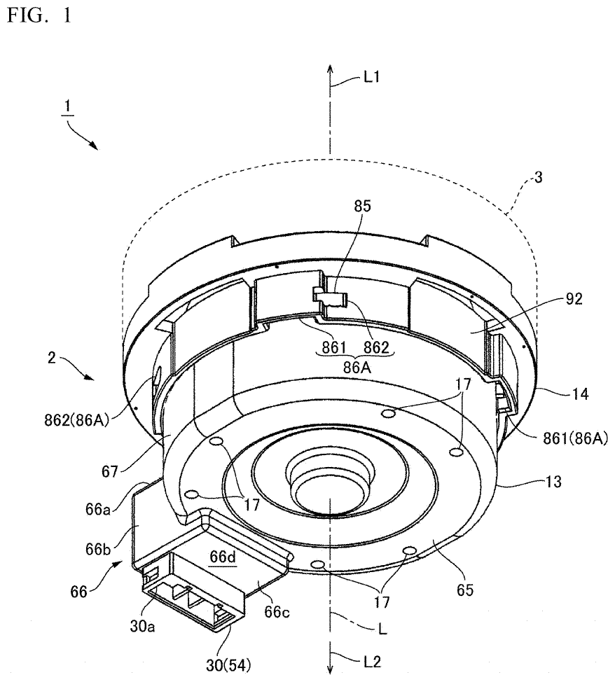

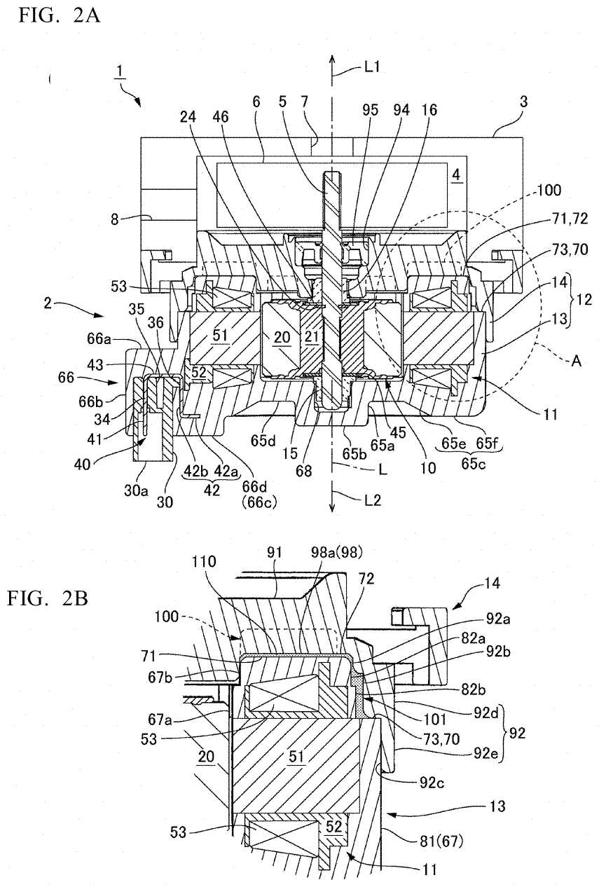

FIG. 1 is an external perspective view of a pump apparatus 1 to which at least an embodiment of the present invention is applied. Furthermore, FIG. 2A is a cross-sectional view of the pump apparatus 1, and FIG. 2B is a partially enlarged view of a region A of FIG. 2A. The pump apparatus 1 includes: a motor 2; a case body 3 attached to the motor 2 and forming a pump chamber 4 between the case body 3 and the motor 2; and an impeller 6 attached to a rotary shaft 5 of the motor 2 and disposed in the pump chamber 4. The case body 3 is provided with a suction inlet 7 and a discharge outlet 8 for fluids. When the motor 2 is driven to rotate the impeller 6, a fluid such as water sucked through the suction inlet 7 is discharged through the discharge outlet 8 via the pump chamber 4.

In this description, the reference symbol L indicates the direction of the axis of the motor 2; an output side L1 is one side in the direction of an axis L, and an opposite output side L2 is the other side in the direction of the axis L. FIG. 1 is an external perspective view of the pump apparatus 1 when viewed from the opposite output side L2. The rotary shaft 5 of the motor 2 extends in the direction of the axis L. Further, the side on which the impeller 6 is disposed with respect to the motor 2 is the output side L1, and the side opposite to the output side L1 is the opposite output side L2. Further, the direction perpendicular to the axis L is defined as a radial direction, and the circumference of the axis L is defined as a circumferential direction. As illustrated in FIG. 2A and FIG. 2B, the suction inlet 7 is provided at the position overlapped with the axis L of the rotary shaft 5 of the motor 2 in the case body 3, and the discharge outlet 8 is provided outside the rotary shaft 5 in the radial direction.

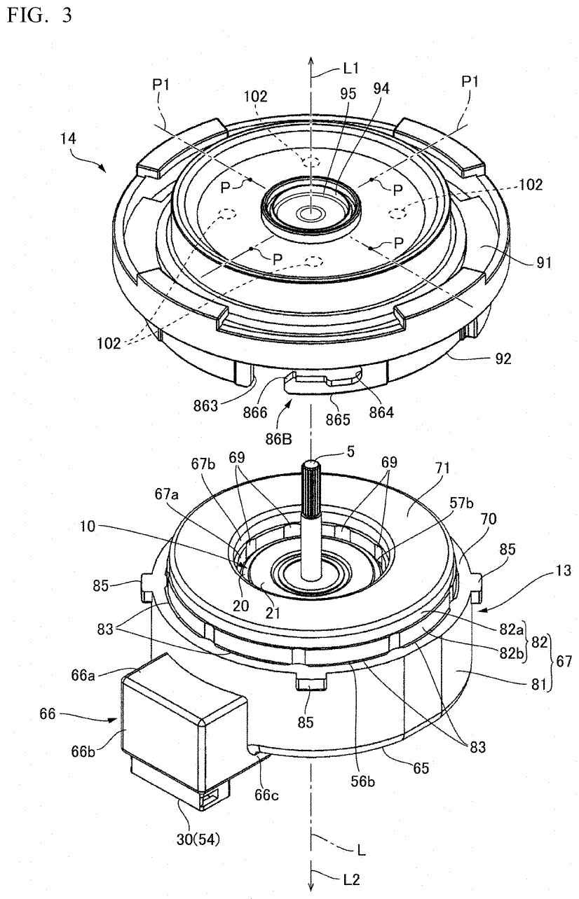

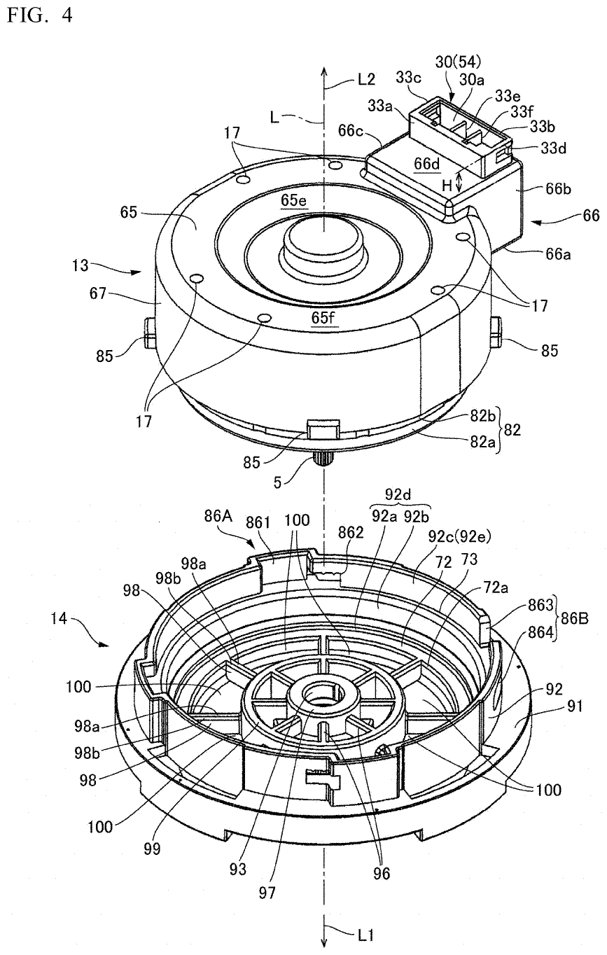

FIG. 3 is an exploded perspective view of the motor 2 when viewed from the output side L1, and FIG. 4 is an exploded perspective view of the motor when viewed from the opposite output side L2. FIG. 3 and FIG. 4 illustrate a state in which a cover member 14 forming a housing 12 of the motor 2 is removed from a resin sealing member 13. The motor 2 is a DC brushless motor and includes a rotor 10, a stator 11, and the housing 12 accommodating them. The housing 12 includes: the resin sealing member 13 covering the stator 11 from the opposite output side L2; and the cover member 14 covering the resin sealing member 13 from the output side L1. The cover member 14 is fixed to the resin sealing member 13.

The case body 3 is placed on the cover member 14 from the output side L1. Thus, the space partitioned between the cover member 14 and the case body 3 is the pump chamber 4. The resin sealing member 13 holds a first bearing member 15 that rotatably supports the end of the rotary shaft 5 of the rotor 10 at the opposite output side L2. The cover member 14 holds a second bearing member 16 that rotatably supports the middle of the rotary shaft 5. The end of the rotary shaft 5 at the output side L1 protrudes into the pump chamber 4 from the housing 12 of the motor 2 and is attached with the impeller 6.

### (Rotor)

As illustrated in FIG. 2A and FIG. 2B, the rotor 10 includes: the rotary shaft 5; a magnet 20 surrounding the rotary shaft 5; and a holding member 21 that holds the rotary shaft 5 and the magnet 20. The magnet 20 has a ring shape and disposed coaxially with the rotary shaft 5. On an outer peripheral surface of the magnet 20, an N pole and an S pole are alternately magnetized in the circumferential direction. The rotary shaft 5 is made of stainless steel. The rotary shaft 5 has an annular groove formed near the center in the direction of the axis L, and an E-ring 24 is fixed to the annular groove. The E-ring 24 is a plate-like member made of metal. The E-ring 24 is embedded in the end surface of the holding member 21 at the output side L1.

The rotor 10 includes a first bearing plate 45 disposed on the opposite output side L2 of the holding member 21 and a second bearing plate 46 disposed on the output side L1 of the holding member 21. The first bearing plate 45 and the second bearing plate 46 are substantially annular metal plates. For example, the first bearing plate 45 and the second bearing plate 46 are metal washers. The first bearing plate 45 covers the end surface of the holding member 21 at the opposite output side L2 in a state where the rotary shaft 5 penetrates a center hole of the first bearing plate 45. Further, the second bearing plate 46 covers the end surface of the holding member 21 at the output side L1 and the E-ring 24 in a state where the rotary shaft 5 penetrates a center hole of the second bearing plate 46. The second bearing plate 46 makes surface contact with the E-ring 24. The first bearing plate 45 and the second bearing plate 46 are held by the end surface of the holding member 21 at the opposite output side L2 and the end surface thereof at the output side L1, respectively. The sliding heat generated due to the sliding between the second bearing plate 46 and the second bearing member 16 during the rotation of the rotor 10 is transmitted to the rotary shaft 5 via the E-ring 24 and is released.

### (Stator)

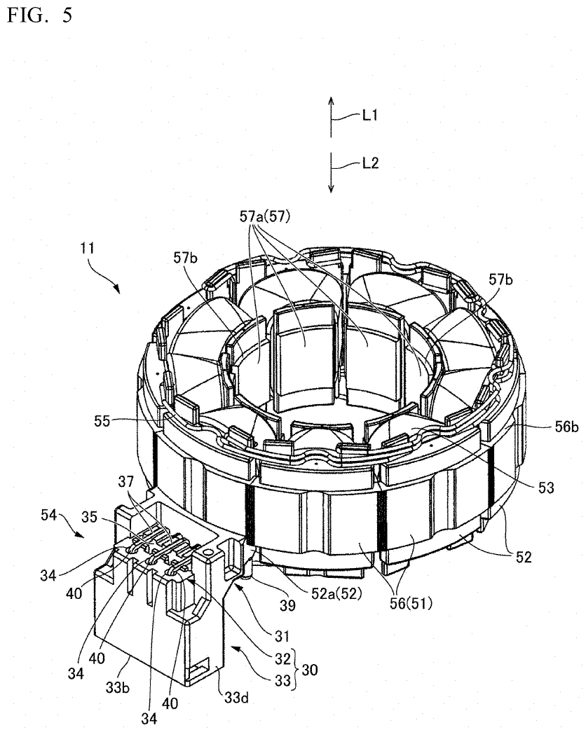

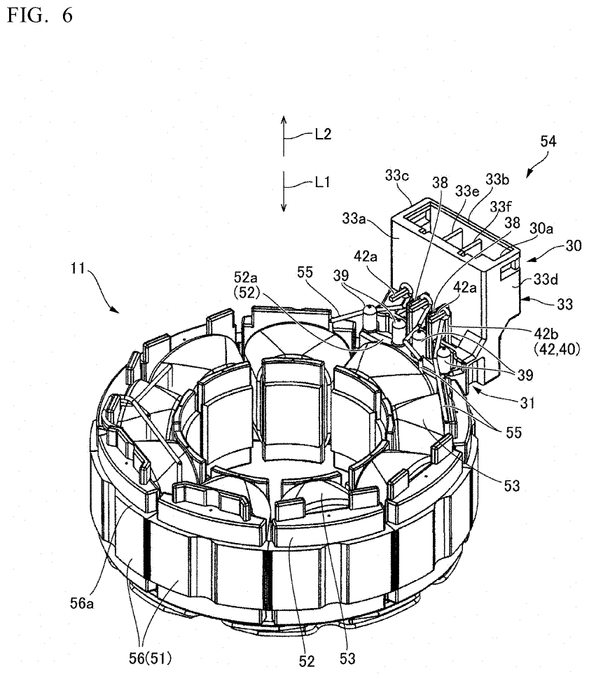

FIG. 5 and FIG. 6 are perspective views of the stator 11; FIG. 5 is a perspective view when viewed from the opposite output side L2, and FIG. 6 is a perspective view when viewed from the output side L1. The stator 11 includes: a ring-shaped stator core 51 located on the outer peripheral side of the rotor 10; a plurality of coils 53 wound around the stator core 51 via an insulator 52; and a connector 54 for connecting an electric supply line through which electricity is supplied to each of the coils 53.

The stator core 51 is a laminated core formed by laminating thin magnetic plates made of a magnetic material. As illustrated in FIG. 5 and FIG. 6, the stator core 51 includes a ring-shaped part 56 and a plurality of salient-pole parts 57 protruding from the ring-shaped part 56 inward in the radial direction. The salient-pole parts 57 are formed at an equal angle pitch and are arranged at a constant pitch in the circumferential direction. An inner-peripheral side end surface 57a of each of the salient-pole parts 57 is an arc surface with the axis L as a center. The inner-peripheral side end surface 57a of the salient-pole part 57 is opposed to the outer peripheral surface of the magnet 20 of the rotor 10 with a slight gap interposed therebetween.

The insulator 52 is formed of an insulating material such as resin. The insulator 52 has a cylindrical flanged shape having flanges at both ends in the radial direction. The insulator 52 is attached to each of the salient-pole parts 57. The coil 53 is wound around each of the salient-pole parts 57 via the insulator 52. Furthermore, the insulator 52 partially covers an opposite output-side end surface 56a (see FIG. 6) of the ring-shaped part 56 of the stator core 51, but the insulator 52 does not cover the outer peripheral edge section of the opposite output-side end surface 56a. Similarly, the insulator 52 partially covers an output-side end surface 56b (see FIG. 5) of the ring-shaped part 56 of the stator core 51, but the insulator 52 does not cover the outer peripheral edge section of the output-side end surface 56b.

The coil 53 is formed of a conductive wire 55 made of an aluminum alloy or a copper alloy. According to the present embodiment, the conductive wire 55 in which an aluminum alloy is covered with a copper alloy is used. Further, according to the present embodiment, the number of the salient-pole parts 57 and the number of the coils 53 are each nine. The motor 2 is a three-phase brushless motor; three of the nine coils 53 are U-phase coils, three of the remaining six are V-phase coils, and the remaining three are W-phase coils. The U-phase coil, the V-phase coil, and the W-phase coil are arranged in the circumferential direction in this order. The three U-phase coils are formed by sequentially winding the single conducive wire 55 around the three salient-pole parts 57, the three V-phase coils are formed by sequentially winding the single conducive wire 55 around the three salient-pole parts 57, and the three W-phase coils are formed by sequentially winding the single conductive wire 55 around the three salient-pole parts 57. The conductive wire 55 forming the U-phase coil, the V-phase coil, and the W-phase coil is drawn to the connector 54.

### (Connector)

The connector 54 is shaped so that a male external connector is attachable thereto and detachable therefrom. The connector 54 is connected to one of the plurality of insulators 52. The connector 54 includes: a substantially rectangular parallelepiped connector housing 30; a connection part 31 connecting the connector housing 30 and the insulator 52; and a terminal pin 40 held by the connector housing 30. The connector housing 30 is disposed on the outer peripheral side of the insulator 52 and on the opposite output side L2 of the stator core 51, and is connected, via the connection part 31, to a part (a flange 52a) of the insulator 52 located on the outer peripheral side of the coil 53. The connector housing 30 and the connection part 31 are formed integrally with the insulator 52.

The connector 54 is the female connector 54 including the three terminal pins 40, i.e., the terminal pin 40 to which one end of the conductive wire 55 forming the U-phase coil is connected, the terminal pin 40 to which one end of the conductive wire 55 forming the V-phase coil is connected, and the terminal pin 40 to which one end of the conductive wire 55 forming the W-phase coil is connected. The other end of the conductive wire 55 forming the U-phase coil, the other end of the conductive wire 55 forming the V-phase coil, and the other end of the conductive wire 55 forming the W-phase coil are connected to one another to form a common wire.

The connector housing 30 has substantially a rectangular parallelepiped shape and is opened at the opposite output side L2. That is, in the connector housing 30, a connection opening 30a that is opened at the opposite output side L2 is formed. The connector housing 30 includes: a tubular part 33 having a rectangular tubular shape and extending in the direction of the axis L; and a bottom part 32 closing the end of the tubular part 33 at the output side L1. The connection opening 30a is provided at the end of the tubular part 33 at the opposite output side L2. As illustrated in FIG. 6, the tubular part 33 includes: an inner side wall 33a located at the center side (i.e., the side of the insulator 52) of the stator 11; an outer side wall 33b parallel to the inner side wall 33a; and side walls 33c, 33d connecting the inner side wall 33a and the outer side wall 33b. The internal space of the connector housing 30 is divided into three by partition walls 33e, 33f that are parallel to the side walls 33c, 33d. A terminal connection part 41 (see FIG. 2A), which is the end of the terminal pin 40, is disposed one by one in each of the spaces partitioned by the partition walls 33e and 33f When the male external connector is attached to the connection opening 30a, the terminal provided on the external connector is brought into contact with the terminal pin 40.

As illustrated in FIG. 5, the same number of through holes 34 as the terminal pins 40 are formed in the bottom part 32. As the three terminal pins 40 are attached to the connector housing 30 according to the present embodiment, the through holes 34 are formed at three places. The through holes 34 at the three places are arranged in a line in a direction perpendicular to the radial direction of the stator 11. As illustrated in FIG. 2A and FIG. 5, a recess 35 is formed on the surface of the bottom part 32 at the output side L1 so as to be located inward in the radial direction (i.e., on the side of the insulator 52) with respect to the through hole 34. The recess 35 has a recessed shape that is depressed toward the opposite output side L2 and extends in a groove shape along the direction in which the three through holes 34 are arranged. Further, on the surface of the connection part 31 at the output side L1, the same number of through holes 36 (see FIG. 2A) as the through holes 34 are provided. That is, on the surface of the connector 54 at the output side L1, the through holes 34 and the through holes 36 in three pairs are provided. Between the through holes 34 and the through holes 36 in three pairs, holding grooves 37 (see FIG. 5) intersecting the recess 35 is provided. The part (a coupling part 43 described later) of the terminal pin 40 extending from the through hole 34 to the through hole 36 is held by the holding groove 37.

The terminal pin 40 is formed by bending a metal wire having a rectangular shape in cross-section. Furthermore, the terminal pin 40 may be formed by bending a metal wire having a circular shape in cross-section. As illustrated in FIG. 2A, the terminal pin 40 includes: a terminal connection part 41 that is pressed and fitted into the connector housing 30 and protrudes toward the connection opening 30a; a conductive-wire connection part 42 disposed between the connector housing 30 and the insulator 52; and a coupling part 43 connecting the terminal connection part 41 and the conductive-wire connection part 42. The terminal connection part 41 and the conductive-wire connection part 42 extend in parallel with the direction of the axis L. Further, the coupling part 43 extends in the direction perpendicular to the direction of the axis L and is connected to the terminal connection part 41 and the conductive-wire connection part 42 substantially at right angles.

The terminal pin 40 is attached to the connector housing 30 by pressing and fitting the terminal connection part 41 into the through hole 34 in the direction of the axis L and passing the conductive-wire connection part 42 through the through hole 36. As described above, by holding the coupling part 43 in the holding groove 37 formed on the outer side surface of the connector housing 30, the rotation of the terminal pin 40 is prevented. The tip of the conductive-wire connection part 42 is provided with a detachment preventing part 42a that is formed by bending the tip part of the conductive-wire connection part 42 at substantially right angle inward in the radial direction after being assembled to the connector housing 30. That is, the conductive-wire connection part 42 includes a rising part 42b extending along the inner side wall 33a and the detachment preventing part 42a. Moreover, the bending angle of the detachment preventing part 42a may not be substantially the right angle but may be an obtuse angle.

As illustrated in FIG. 6, the three conductive-wire connection parts 42 are arranged at regular intervals in the direction perpendicular to the radial direction along the inner side wall 33a of the connector housing 30. The connector housing 30 includes a wall part 38 vertically protruding inward in the radial direction from the inner side wall 33a. The wall parts 38 are provided at two positions which are the middle position between the adjacent conductive-wire connection parts 42. The edge of the wall part 38 on the inner side in the radial direction is located inward of the rising part 42b in the radial direction. On the other hand, the edge of the wall part 38 in the direction of the axis L is located closer to the output side L1 than the detachment preventing part 42a. That is, the wall part 38 has a width that extends between the adjacent rising parts 42b and has a height that does not reach between the adjacent detachment preventing parts 42a.

As illustrated in FIG. 6, the insulator 52 located on the inner peripheral side of the connector 54 includes a flange part 52a that is provided on the outer peripheral side of the coil 53. The insulator 52, formed integrally with the connector 54, includes four cylindrical guide protruding parts 39 that protrude from the surface of the flange part 52a on the opposite output side L2, which covers the outer peripheral surface of the stator core 51. The four guide protruding parts 39 are arranged at a constant pitch in the circumferential direction. The conductive wires 55 are connected one by one to the respective three conductive-wire connection parts 42. The three conductive wires 55 forming the U-phase coil, the V-phase coil, and the W-phase coil are guided by the four guide protruding parts 39 and drawn from the coils 53 to the conductive-wire connection parts 42. Specifically, the four guide protruding parts 39 guide one of the three conductive wires 55 from the coil 53 located on the inner peripheral side of the connector housing 30 to the middle conductive-wire connection part 42 among the three, guide one of the remaining two from the coil 53 located on one side, in the circumferential direction, of the coil 53 located on the inner peripheral side of the connector housing 30 to the conductive-wire connection part 42 located at the end on one side in the circumferential direction, and guide the last one from the coil 53 located on the other side, in the circumferential direction, of the coil 53 located on the inner peripheral side of the connector housing 30 to the conductive-wire connection part 42 located at the end on the other side in the circumferential direction.

The conductive wire 55 is guided by the guide protruding part 39, drawn toward the conductive-wire connection part 42, and drawn to the detachment preventing part 42a along the rising part 42b. The conductive wire 55 routed along the rising part 42b is prevented from being short-circuited by the wall part 38. The conductive wire 55 is wound around the rising part 42b or the detachment preventing part 42a and is soldered to the rising part 42b or the detachment preventing part 42a. As described above, as the wall part 38 has such a height that it does not reach the detachment preventing part 42a, soldering is possible by bringing the soldering iron close to the upper ends of the detachment preventing part 42a and the rising part 42b without being interrupted by the wall part 38.

### (Resin Sealing Member)

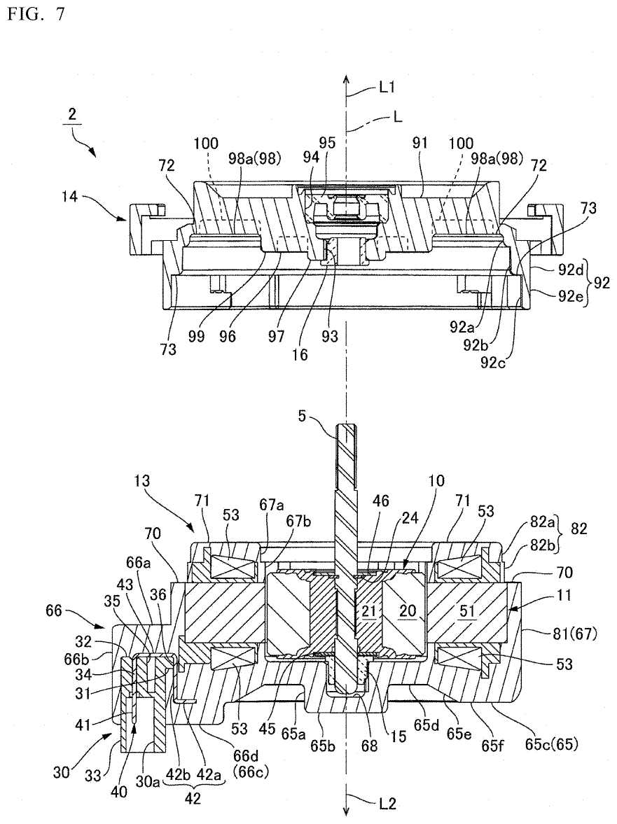

FIG. 7 is an exploded cross-sectional view of the motor 2 and is a cross-sectional view of the state in which the cover member 14 is separated from the resin sealing member 13. As illustrated in FIG. 2 to FIG. 4 and FIG. 7, the resin sealing member 13 includes a sealing member bottom part 65 having substantially a disk-shape and covering the coil 53, the insulator 52, and the stator core 51 at the opposite output side L2. Further, the resin sealing member 13 includes a connector sealing part 66 extending from the sealing member bottom part 65 to the outer peripheral side and covering the connector 54; and a sealing-member cylindrical part 67 extending from the sealing member bottom part 65 to the output side L1 and covering the coil 53, the insulator 52, and the stator core 51. The sealing-member cylindrical part 67 is thick and has a cylindrical shape. The central axis of the sealing-member cylindrical part 67 coincides with the axis L of the motor 2.

A bearing-member holding recess 68 is provided at the central part of the sealing member bottom part 65. The first bearing member 15 that rotatably supports the end of the rotary shaft 5 of the rotor 10 at the opposite output side L2 is held in the bearing-member holding recess 68. The first bearing member 15 is made of resin and has a shape including: a cylindrical support part provided with a through hole in which the rotary shaft 5 is disposed; and a flange part extending outward from the end of the cylindrical part at the output side L1. The contour shape of the first bearing member 15 as viewed in the direction of the axis L is a D-shape. The first bearing member 15 is fixed to the bearing-member holding recess 68 in a state where the flange part abuts the sealing member bottom part 65 at the output side L1. In the first bearing member 15, the support part through which the rotary shaft 5 is inserted functions as a radial bearing for the rotary shaft 5, and the flange part functions as a thrust bearing for the rotor 10. That is, the first bearing plate 45 fixed to the holding member 21 of the rotor 10 slides on the flange part of the first bearing member 15.

As illustrated in FIG. 2A and FIG. 2B, the sealing member bottom part 65 includes: a cylindrical bearing support section 65a surrounding the outer peripheral side of the first bearing member 15 in the radial direction; a circular closing section 65b closing the lower end opening of the bearing support section 65a; a coil sealing section 65c located under the coil 53; and a connecting section 65d connecting the bearing support section 65a and the coil sealing section 65c. The bearing support section 65a and the closing section 65b constitute the bearing-member holding recess 68. The surface of the coil sealing section 65c on the opposite output side L2 includes: a tapered surface 65e that is inclined toward the opposite output side L2 as it goes to the outer peripheral side along the shape of each of the coils 53 wound around the insulator 52; and an annular surface 65f provided on the outer peripheral side of the tapered surface 65e and is perpendicular to the direction of the axis L.

As illustrated in FIG. 2A, FIG. 4, and FIG. 5, the connector sealing part 66 has substantially a rectangular parallelepiped shape as a whole. The connector sealing part 66 includes: a connector sealing-member bottom part 66a covering the connector 54 at the output side L1; a connector sealing-member outer peripheral part 66b covering the outer side of the connector 54 in the radial direction and both sides thereof in the circumferential direction; and a connector sealing-member inner peripheral part 66c located on the inner peripheral side of the connector housing 30, covering the connection part 31 at the opposite output side L2, and protruding from the sealing member bottom part 65 to the opposite output side L2. The connector sealing-member bottom part 66a and the connector sealing-member outer peripheral part 66b protrude from the sealing-member cylindrical part 67 to the outer peripheral side. Further, the connector sealing-member inner peripheral part 66c has a shape that further rises relative to the annular surface 65f of the sealing member bottom part 65. That is, an end surface 66d of the connector sealing-member inner peripheral part 66c at the opposite output side L2 is located at a position that further protrudes to the opposite output side L2 relative to the annular surface 65f of the sealing member bottom part 65.

In the connector 54, the end of the connector housing 30 having the connection opening 30a, through which the male connector is attached and detached, protrudes from the connector sealing part 66 toward the opposite output side L2 so as to be exposed to the outside. The connection opening 30a is provided at a position protruded by a dimension H (see FIG. 4) from the end surface 66d of the connector sealing part 66 at the opposite output side L2. In the connector 54, only the end of the connector housing 30 having the connection opening 30a is exposed to the outside, and the coupling part 43 and the conductive-wire connection part 42 of the terminal pin 40 are completely covered with the connector sealing part 66. Therefore, the connector sealing part 66 prevents the terminal pin 40 from coming off and protects the terminal pin 40 from fluids. Moreover, the conductive wire 55 drawn from the coil 53 to the connector 54 is also covered with the connector sealing part 66 so as to be protected from fluids.

As illustrated in FIG. 2 and FIG. 3, the sealing-member cylindrical part 67 includes: a large-diameter cylindrical section 81 connected to the sealing member bottom part 65; and a small-diameter cylindrical section 82 having an outer diameter smaller than the large-diameter cylindrical section 81. The small-diameter cylindrical section 82 includes: a first small-diameter cylindrical section 82a forming the end of the sealing-member cylindrical part 67 at the output side L1; and a second small-diameter cylindrical section 82b provided between the first small-diameter cylindrical section 82a and the large-diameter cylindrical section 81. The first small-diameter cylindrical section 82a is slightly smaller in the outer diameter than the second small-diameter cylindrical section 82b.

On the outer peripheral surface of the sealing-member cylindrical part 67, a resin sealing-member side position restricting surface 70, which is a stepped surface facing the output side L1, is formed at the boundary area between the second small-diameter cylindrical section 82b and the large-diameter cylindrical section 81. The resin sealing-member side position restricting surface 70 is perpendicular to the direction of the axis L. As described later, the resin sealing-member side position restricting surface 70 is a surface that abuts the cover member 14 in the direction of the axis L. Further, the sealing-member cylindrical part 67 includes, at the end on the output side L1, a resin sealing-member side fixing surface 71 that is an annular end surface perpendicular to the direction of the axis L. As described later, the resin sealing-member side fixing surface 71 is opposed to the cover member 14 with a predetermined gap. The cover member 14 is fixed to the resin sealing member 13 with the adhesive provided in the gap between the resin sealing-member side fixing surface 71 and the cover member 14.

The outer diameter of the large-diameter cylindrical section 81 is larger than the outer diameter of the ring-shaped part 56 of the stator core 51, and the outer diameter of the second small-diameter cylindrical section 82b is smaller than the outer diameter of the ring-shaped part 56 of the stator core 51. Further, the resin sealing-member side position restricting surface 70 is located on the same plane as an opposite output-side end surface 56a of the ring-shaped part 56 of the stator core 51. Therefore, the inner peripheral section of the resin sealing-member side position restricting surface 70 is provided with a plurality of arc-shaped openings 83 (See FIG. 3) that cause the outer peripheral edge section of the opposite output-side end surface 56a of the ring-shaped part 56 of the stator core 51 is exposed to the output side L1.

As illustrated in FIG. 2A, FIG. 2B and FIG. 3, the inner peripheral surface of the sealing-member cylindrical part 67 is provided with, from the opposite output side L2 to the output side L1, a small-diameter inner peripheral surface section 67a and a large-diameter inner peripheral surface section 67b having a larger inner diameter dimension than the small-diameter inner peripheral surface section 67a. As illustrated in FIG. 2A and FIG. 2B, the small-diameter inner peripheral surface section 67a is provided with a plurality of openings for causing the inner-peripheral side end surface 57a of each of the salient-pole parts 57 of the stator core 51 to be exposed to the inner peripheral side. Further, as illustrated in FIG. 3, a plurality of groove-shaped notches 69 extending in the direction of the axis L are provided in the small-diameter inner peripheral surface section 67a. Each of the notches 69 is located at the center of each of the salient-pole parts 57 of the stator core 51 in the circumferential direction and extends from an output-side end surface 57b (see FIG. 5) of the salient-pole part 57 to the end surface of the small-diameter inner peripheral surface section 67a at the output side L1. Therefore, at the angular position where the notch 69 is provided, the output-side end surface 57b of the salient-pole part 57 of the stator core 51 is exposed to the output side L1.

The outer peripheral surface of the large-diameter cylindrical section 81 is provided with four engagement projections 85 that protrude outward at equal angular intervals. The engagement projection 85 engages with a rotational engagement part 86 provided on the cover member 14 as described later. The engagement projection 85 engages with the rotational engagement part 86 to prevent the cover member 14 from coming off the resin sealing member 13.

The resin sealing member 13 completely covers the coil 53 and protects the coil 53 from fluids. Furthermore, the resin sealing member 13 is integrally formed including also the connector sealing part 66 covering the connector 54 except for the opening (the connection opening 30a), through which the male connector is attached and detached, so that it prevents the terminal pin 40 assembled to the connector 54 from being removed and protects the connection part between the terminal pin 40 and the conductive wire 55 from fluids. The resin sealing member 13 is formed of BMC (Bulk Molding Compound). According to the present embodiment, the resin sealing member 13 is formed by disposing the stator 11 in a mold and injecting and curing a resin material in the mold. That is, the resin sealing member 13 is integrally molded with the stator 11 by insert molding.

When insert molding is performed, resin is injected into the mold to mold the resin sealing member 13 in a state where the stator core 51 disposed in the mold is positioned in contact with the mold in the radial direction and in the direction of the axis L. This improves the accuracy of the relative position between the stator core 51 and the resin sealing member 13. For example, a cylindrical mold part is provided in the mold, and the outer peripheral surface of the mold part is in contact with the inner-peripheral side end surface 57a of each of the salient-pole parts 57 so that the stator core 51 is positioned in the radial direction. As a result, as described above, the inner-peripheral side end surface 57a of each of the salient-pole parts 57 of the stator core 51 is exposed from the resin sealing member 13. Moreover, when insert molding is performed, the mold is provided with a first contact area that may be in contact with the output-side end surface 57b of each of the salient-pole parts 57 and a second contact area that may be in contact with the output-side end surface 56b of the ring-shaped part 56, and the first contact area and the second contact area are brought into contact with the stator core 51 to position the stator core 51 in the direction of the axis L. As a result, as described above, part of the output-side end surface 57b of each of the salient-pole parts 57 of the stator core 51 is exposed to the output side L1. Further, the outer peripheral section of the output-side end surface 56b of the ring-shaped part 56 is exposed to the output side L1.

As illustrated in FIG. 4, the sealing member bottom part 65 is provided with a plurality of holes 17 communicating from the surface of the sealing member bottom part 65 on the opposite output side L2 to the end surface of the insulator 52 on the opposite output side L2. According to the present embodiment, the six holes 17 are formed in the sealing member bottom part 65. Specifically, a pair of the two holes 17 arranged at a pitch of 40° with the axis L as a center is formed at three positions at a pitch of 120°. The holes 17 have a shape corresponding to a pressing pin for pressing the stator 11 set in the mold during molding in the direction of the axis L to be pressed against the support surface (the first contact area and the second contact area described above) in the mold.

### (Cover Member)

FIG. 7 is an exploded cross-sectional view of the motor and illustrates a state in which the cover member 14 is removed from the resin sealing member 13. The cover member 14 is made of resin and is fixed to the output side L1 of the resin sealing member 13. The cover member 14 includes: a disk-shaped cover-member ceiling part 91; and a cover-member cylindrical part 92 protruding from the cover-member ceiling part 91 to the opposite output side L2. At the center of the cover-member ceiling part 91, a through hole 93 penetrating in the direction of the axis L is provided. A circular recess 94 surrounding the through hole 93 is provided at the center of the surface of the cover-member ceiling part 91 on the output side L1, and an annular seal member 95 is disposed in the circular recess 94. The seal member 95 is disposed in the gap between the rotary shaft 5 and the cover member 14.

As illustrated in FIG. 4 and FIG. 7, a bearing-member holding cylindrical part 97, which is coaxial with the through hole 93, is provided at the center area of the surface of the cover-member ceiling part 91 on the opposite output side L2. As illustrated in FIG. 2 and FIG. 7, the second bearing member 16 is held in the center hole of the bearing-member holding cylindrical part 97. The second bearing member 16 is formed by arranging the same member as the above-described first bearing member 15 such that it is reversed in the direction of the axis L. Specifically, the second bearing member 16 is made of resin, and it has a shape including a cylindrical support part provided with a through hole in which the rotary shaft 5 is disposed and a flange part extending outward from the end of the cylindrical part at the opposite output side L2. The second bearing member 16 is fixed to the bearing-member holding cylindrical part 97 in a state where the flange part is in contact with the bearing-member holding cylindrical part 97 at the opposite output side L2. In the second bearing member 16, a support part through which the rotary shaft 5 is inserted functions as a radial bearing for the rotary shaft 5, and a flange part functions as a thrust bearing for the rotor 10. That is, the second bearing plate 46 fixed to the holding member 21 of the rotor 10 slides on the flange part of the second bearing member 16.

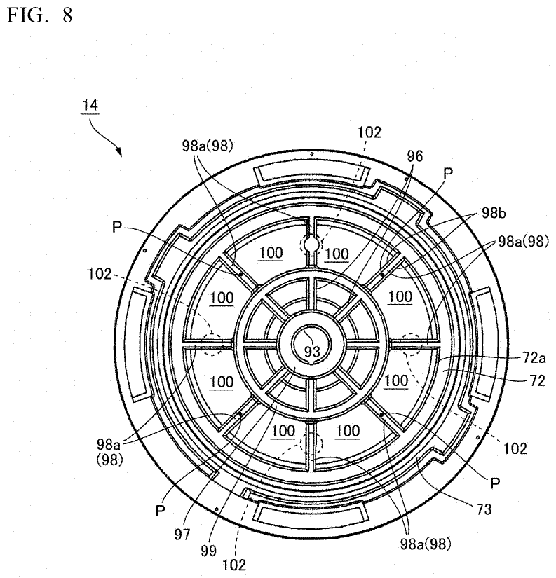

FIG. 8 is a plan view of the cover member 14 as viewed from the opposite output side L2. As illustrated in FIG. 4, FIG. 7 and FIG. 8, a ring-shaped cover-member side fixing surface 72, connected to the inner peripheral surface of the cover-member cylindrical part 92, is provided along the outer peripheral edge on the surface of the cover-member ceiling part 91 on the opposite output side L2. Furthermore, an inner annular rib 99 having a circular shape is provided between the bearing-member holding cylindrical part 97 and the cover-member side fixing surface 72 on the surface of the cover-member ceiling part 91 on the opposite output side L2. The bearing-member holding cylindrical part 97, the cover-member side fixing surface 72, and the inner annular rib 99 are coaxial. Further, a plurality of radial ribs 98 and a plurality of first adhesive reservoirs 100 are provided between the inner annular rib 99 and the cover-member side fixing surface 72. Moreover, a plurality of radial ribs 96 is provided between the inner annular rib 99 and the bearing-member holding cylindrical part 97.

The inner annular rib 99 and the radial ribs 98, 96 are protruding parts that protrude to the opposite output side L2. Further, the first adhesive reservoir 100 is a recessed part that is depressed toward the output side L1 relative to the cover-member side fixing surface 72 and a tip surface 98a of the radial rib 98. The first adhesive reservoir 100 is a recess that uses the recessed shape of the cover member 14. That is, the first adhesive reservoir 100 also serves as a recessed shape of the cover member 14. Further, on the inner peripheral side of the inner annular rib 99, too, a recess having a depressed shape is formed between the radial ribs 96.

According to the present embodiment, the eight radial ribs 98 are radially disposed at an angular interval of 45 degrees. Furthermore, the radial rib 96 is disposed at the same angular position as the radial rib 98. The first adhesive reservoir 100 is a recess having substantially a fan shape and provided between the two radial ribs 98 that are adjacent in the circumferential direction and is provided at eight positions according to the present embodiment. Each of the first adhesive reservoirs 100 is partitioned by the radial ribs 98 at both sides in the circumferential direction, and the inner peripheral side is partitioned by the inner annular ribs 99. Moreover, each of the first adhesive reservoirs 100 is disposed on the inner peripheral side of the cover-member side fixing surface 72.

The amount of protrusion of the bearing-member holding cylindrical part 97 to the opposite output side L2 is larger than the amount of protrusion of the inner annular rib 99. Further, the inner annular rib 99 and the radial rib 96 further protrude to the opposite output side L2 relative to the cover-member side fixing surface 72. Further, the tip surface 98a of the radial rib 98 is located on the same plane as the cover-member side fixing surface 72. The tip surface of the bearing-member holding cylindrical part 97, the tip surface of the inner annular rib 99, the tip surfaces of the radial ribs 98 and 96, and the cover-member side fixing surface 72 are all planes perpendicular to the axis L. A chamfered surface is provided on the outer peripheral side and both circumferential edges of the first adhesive reservoir 100. That is, a chamfered surface 72a is provided at the inner peripheral edge of the cover-member side fixing surface 72. Moreover, a chamfered surface 98b is provided at the corner connecting the tip surface 98a of the radial rib 98 and the side surface. Moreover, a chamfered surface is also provided at the edge of the radial rib 96 and the inner annular rib 99.

As illustrated in FIG. 4, FIG. 7, the inner diameter of the cover-member cylindrical part 92 gradually becomes larger as it goes to the opposite output side L2 from the output side L1. That is, the inner peripheral surface of the cover-member cylindrical part 92 includes, in order from the output side L1, a first small-diameter inner peripheral surface 92a, a second small-diameter inner peripheral surface 92b, and a large-diameter inner peripheral surface 92c. At the boundary area between the second small-diameter inner peripheral surface 92b and the large-diameter inner peripheral surface 92c, a cover-member side position restricting surface 73 is formed, which is an annular stepped surface facing the opposite output side L2. The cover-member side position restricting surface 73 is a plane perpendicular to the axis L.

The cover-member cylindrical part 92 includes an upper annular cylindrical section 92d that is overlapped with the small-diameter cylindrical section 82 of the resin sealing member 13 in the direction of the axis L to cover the small-diameter cylindrical section 82 of the resin sealing member 13 at the outer peripheral side; and a lower annular cylindrical section 92e that is located on the outer peripheral side of the large-diameter cylindrical section 81 of the resin sealing member 13. The upper annular cylindrical section 92d is a section on the output side L1 relative to the cover-member side position restricting surface 73. Furthermore, the lower annular cylindrical section 92e is a protruding part that protrudes to the opposite output side L2 relative to the cover-member side position restricting surface 73 to cover the outer peripheral side of the resin sealing member 13.

As illustrated in FIG. 4, in the lower annular cylindrical section 92e of the cover-member cylindrical part 92, rotational engagement parts 86 engaged with the engagement projections 85 of the resin sealing member 13 are provided at four positions in the circumferential direction. As illustrated in FIG. 3 and FIG. 4, three of the rotational engagement parts 86 at four positions are first rotational engagement parts 86A including: a groove 861 extending from the edge of the cover-member cylindrical part 92 at the opposite output side L2 to the output side L1; and a substantially rectangular notch 862 connected to the groove 861 and extending in the circumferential direction. Further, the remaining one is a second rotational engagement part 86B including: a notch 863 extending from the edge of the cover-member cylindrical part 92 on the opposite output side L2 to the output side L1; and a notch 864 connected to the notch 863 and extending in the circumferential direction. In the second rotational engagement part 86B, an arm part 865 provided on the opposite output side L2 of the notch 864 is elastically deformable, and the arm part 865 is provided with a hook part 866 that may be engaged with the engagement projection 85 in the circumferential direction.

### (Positioning Structure and Fixing Structure of the Cover Member)

The cover member 14 is placed on the resin sealing member 13 at the output side L1 in a state where the rotor 10 is disposed inside the resin sealing member 13 and the rotor 10 is supported by the first bearing member 15. When the cover member 14 is covered on the resin sealing member 13, as illustrated in FIG. 2, the lower end part of the inner annular rib 99 is fitted into the inner peripheral side of the sealing-member cylindrical part 67 of the resin sealing member 13. Thus, the cover member 14 and the resin sealing member 13 are positioned in the radial direction, and the axis L of the rotary shaft 5 coincides with the central axis of the stator 11. The cover member 14 is positioned in the direction of the axis L when the cover-member side position restricting surface 73 provided on the cover-member cylindrical part 92 abuts the resin sealing-member side position restricting surface 70, which is a stepped surface provided on the outer peripheral surface of the resin sealing member 13, in the direction of the axis L. Thus, the cover-member ceiling part 91 covers the rotor 10 and the resin sealing member 13 from above with the rotary shaft 5 penetrating in the vertical direction. Further, the seal member 95 disposed in the circular recess 94 of the cover-member ceiling part 91 seals the gap between the rotary shaft 5 and the cover member 14 and the second bearing member 16. Moreover, a state is obtained such that the cover-member cylindrical part 92 surrounds the outer peripheral side of the part of the resin sealing member 13 at the output side L1.

Then, the cover member 14 and the resin sealing member 13 are rotated relative to each other in the circumferential direction and, as illustrated in FIG. 1, the engagement projection 85 of the resin sealing member 13 and the rotational engagement part 86 (the first rotational engagement part 86A, the second rotational engagement part 86B) of the cover member 14 are engaged. Specifically, the cover member 14 is rotated in the circumferential direction with respect to the resin sealing member 13 in a state where the engagement projections 85 at four positions are inserted into the grooves 861 or the notch 863 so that the engagement projections 85 are engaged with the notches 862, 864. The cover member 14 and the resin sealing member 13 are positioned in the circumferential direction by engaging one of the engagement projections 85 at four positions with the hook part 866 provided on the second rotational engagement part 86B. When the cover member 14 and the resin sealing member 13 are manually rotated relative to each other in the circumferential direction, the resin sealing member 13 is supported with the connector sealing part 66 projecting outward from the sealing-member cylindrical part 67 as a fulcrum, whereby the cover member 14 may be rotated relative to the resin sealing member 13.

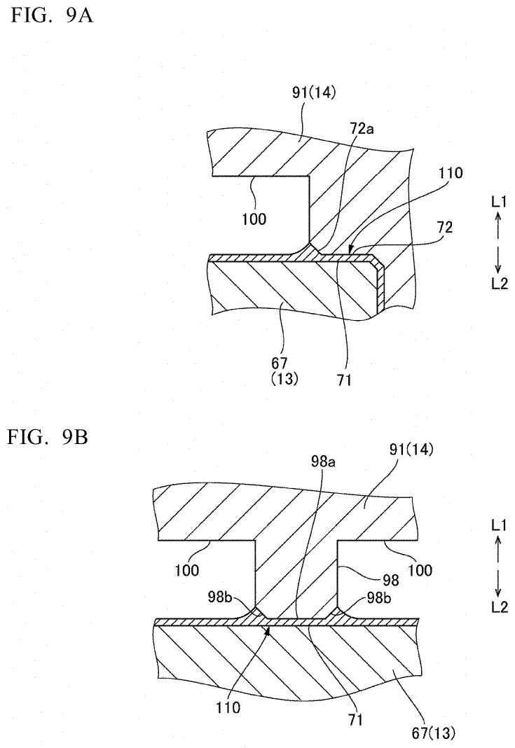

FIG. 9A and FIG. 9B is an enlarged cross-sectional view of an adhesive fixing part between the resin sealing-member side fixing surface 71 and the cover member 14; FIG. 9A is an enlarged cross-sectional view (a partially cross-sectional view in the radial direction) of an adhesive fixing part between the resin sealing-member side fixing surface 71 and the cover-member side fixing surface 72, and FIG. 9B is an enlarged cross-sectional view (a partial cross-sectional view in the circumferential direction) of an adhesive fixing part between the resin sealing-member side fixing surface 71 and the radial rib 98. When the cover member 14 is covered on the resin sealing member 13, an adhesive is applied to the resin sealing-member side fixing surface 71 (see FIG. 3 and FIG. 7) which is the end surface of the sealing-member cylindrical part 67 at the output side L1. When the cover-member side position restricting surface 73 and the resin sealing-member side position restricting surface 70 are in contact with each other in the direction of the axis L, the resin sealing-member side fixing surface 71 is opposed to the cover-member side fixing surface 72 and the tip surface 98a of the radial rib 98 with a predetermined gap.

The adhesive applied to the resin sealing-member side fixing surface 71 is hardened in a state where the gap between the resin sealing-member side fixing surface 71 and the cover-member side fixing surface 72 and the gap between the resin sealing-member side fixing surface 71 and the tip surface 98a of the radial rib 98 are filled. Therefore, as illustrated in FIG. 9A, the cover-member side fixing surface 72 is fixed to the resin sealing-member side fixing surface 71 via an adhesive layer 110. Further, as illustrated in FIG. 9B, the tip surface 98a of the radial rib 98 is fixed to the resin sealing-member side fixing surface 71 via the adhesive layer 110. The resin sealing-member side fixing surface 71 and the cover-member side fixing surface 72 are both annular and are provided on the entire periphery of the cover member 14. As the adhesive layer 110 is thus formed on the entire periphery, the adhesive layer 110 ensures waterproofness.

Here, when the cover member 14 and the resin sealing member 13 are rotated relative to each other in the circumferential direction in order to engage the engagement projection 85 and the rotational engagement part 86 before the adhesive becomes hardened, the adhesive applied to the resin sealing-member side fixing surface 71 is spread in the circumferential direction. Therefore, the adhesive may be distributed to the place where it is desired to be adhered, and the adhesive may be surely distributed to the entire periphery. Further, when the cover member 14 and the resin sealing member 13 are relatively rotated in the circumferential direction, the adhesive enters the space between the chamfered surface 98b provided at the corner of the radial rib 98 and the resin sealing-member side fixing surface 71. When an adhesive with a low viscosity is used, the surface tension causes the adhesive to be collected in a part where the space is large. That is, the adhesive is gathered along the edges of the cover-member side fixing surface 72 and the radial rib 98 where the chamfered surfaces 72a, 98b are provided.

The first adhesive reservoir 100 is provided at an adjacent position on the inner peripheral side with respect to the cover-member side fixing surface 72. Therefore, when an excess adhesive is applied to the resin sealing-member side fixing surface 71, the adhesive spreads to the inner peripheral side of the cover-member side fixing surface 72 and remains in the first adhesive reservoir 100. Therefore, the adhesive is prevented from entering the side of the rotor 10. Further, the adhesive spreads to both sides of the radial rib 98 in the circumferential direction and also remains in the first adhesive reservoir 100.

The cover member 14 includes a second adhesive reservoir 101 that is provided between the cover-member side fixing surface 72 and the cover-member side position restricting surface 73. Specifically, as illustrated in FIG. 2B, the first small-diameter inner peripheral surface 92a and the second small-diameter inner peripheral surface 92b are provided between the cover-member side fixing surface 72 and the cover-member side position restricting surface 73, and the second small-diameter inner peripheral surface 92b is disposed with a predetermined gap in the radial direction from the outer peripheral surface of the small-diameter cylindrical section 82 of the resin sealing member 13. This gap is the second adhesive reservoir 101. Therefore, when an excess adhesive is applied to the resin sealing-member side fixing surface 71, the adhesive spreads from the cover-member side fixing surface 72 to the outer peripheral side and remains in the second adhesive reservoir 101. Thus, the adhesive is prevented from spreading from the gap between the cover member 14 and the resin sealing member 13 to the outer peripheral surface of the motor 2.

### (Position Relationship Between a Gate Mark and the Radial Rib)

The cover member 14 is a resin molded product. As illustrated in FIG. 3, on the surface of the cover member 14 at the output side L1, multiple gate marks 102 are formed, which are marks of an injection port of resin to the mold. The gate marks 102 are annularly arranged at equal angular intervals around the rotary shaft 5. For example, according to the present embodiment, the gate marks 102 are formed at four positions with a pitch of 90° around the rotary shaft 5. Furthermore, the radial ribs 98 are arranged at equal angular intervals around the rotary shaft 5 on the surface of the cover member 14 on the opposite output side L2, and the radial ribs 98 are formed at the positions corresponding to the positions of the gate marks 102. That is, the angular positions of the gate marks 102 and the radial ribs 98 are set such that a midpoint P in the circumferential direction between the gate marks 102 adjacent in the circumferential direction always coincides with the formation position of one of the radial ribs 98.

According to the present embodiment, as illustrated in FIG. 8, the gate marks 102 at four positions are provided at the positions overlapped with four out of the eight radial ribs 98 when viewed in the direction of the axis L. Furthermore, each of the midpoints P in the circumferential direction between the gate marks 102, which are adjacent in the circumferential direction, is located at the position overlapped with the radial rib 98 when viewed in the direction of the axis L. More specifically, the angular positions of the gate mark 102 and the radial rib 98 are set such that the central position of the width of the radial rib 98 in the circumferential direction and the midpoint P are overlapped when viewed in the direction of the axis L. The midpoint P of the gate marks 102 in the circumferential direction coincides with the point (a weld line P1: a virtual line indicated by an alternate long and short dash line in FIG. 3) where resin flowing in from adjacent gates merges when the cover member 14 is molded. Therefore, by matching the angular position of the midpoint P and the angular position of the radial rib 98, the radial rib 98 may be formed on the weld line P1, and the part overlapped with the weld line P1 may be reinforced with the radial rib 98 so that the strength of the cover member 14 may be secured.

### Main Effects of the Present Embodiment

As described above, in the motor 2 and the pump apparatus 1 according to the present embodiment, the resin sealing member 13 covering the stator 11 includes the connector sealing part 66 that protrudes to the outer peripheral side of the stator core 51 and covers the connector 54. Thus, as the resin sealing member 13 is integrally formed, including not only the part covering the stator core 51 and the coil 53 but also the part covering the connector 54, the waterproofness and the impact resistance of the connector 54 may be enhanced. Further, by forming the connector sealing part 66, the terminal pin 40 may be prevented from coming off.

According to the present embodiment, the connector sealing part 66 has a shape that further protrudes to the opposite output side L2 relative to the sealing member bottom part 65 covering the stator core 51 and the coil 53, and the connector housing 30 protrudes from the end surface 66d of the connector sealing part 66 that is provided at the position that further rises relative to the end surface (the annular surface 65f) of the sealing member bottom part 65. Further, the height, in the direction of the axis L, of the connection opening 30a, through which an external connector is attached and detached, from the sealing member bottom part 65 is larger than the height of protrusion of the end surface 66d of the connector sealing part 66 from the sealing member bottom part 65 by the dimension H (see FIG. 4). Therefore, when a liquid is dropped on the sealing member bottom part 65, there is little possibility that the liquid flows into the connection opening 30a from the side of the sealing member bottom part 65. Thus, the waterproofness is high.

According to the present embodiment, the engagement projection 85 is provided on the outer peripheral surface of the resin sealing member 13, and the lower annular cylindrical section 92e of the cover-member cylindrical part 92 includes the rotational engagement part 86 (the first rotational engagement part 86A, the second rotational engagement part 86B) to be engaged with the engagement projection 85 when the cover member 14 is rotated relative to the resin sealing member 13 around the axis L, whereby the cover member 14 may be assembled to the resin sealing member with the rotational engagement structure including the engagement projection 85 and the rotational engagement part 86. Then, as the resin sealing member 13 may be supported with the connector sealing part 66 projecting to the outer peripheral side as a fulcrum, the workability for manually assembling the cover member 14 and the resin sealing member 13 is high. Further, as only the connection opening 30a is exposed to the outside, the connector 54 may be assembled without directly touching the terminal pin 40 of the connector 54 during manual assembly. Furthermore, as the connector 54 is protected by the connector sealing part 66, the load applied to the connector 54 is small when the connector sealing part 66 is used as a fulcrum. Thus, the connector 54 may be protected during assembly.

In the connector 54 according to the present embodiment, the terminal pin 40 is attached to the connector housing 30 by press fitting, and therefore it is possible to prevent resin from entering the connector housing 30 through the through hole 34 for press fitting when the connector sealing part 66 is molded with resin. Thus, resin may be prevented from adhering to the terminal connection part 41 of the terminal pin 40 disposed in the connector housing 30.

The terminal pin 40 according to the present embodiment includes the coupling part 43 extending in a direction intersecting the press-fitting direction of the terminal connection part 41 to the connector housing 30, and the terminal pin 40 is assembled in a state where the coupling part 43 is held in the holding groove 37 formed on the outer side surface of the connector housing. Thus, as the rotation of the terminal pin 40 around the terminal connection part 41 may be prevented, the rotation of the terminal pin 40 during molding of the connector sealing part 66 may be prevented.

In the connector 54 according to the present embodiment, the recess 35, which is recessed in the direction of the axis L, is formed in the bottom part 32 of the connector housing 30. Thus, the provision of the depressed shape (the recess 35) in the connector housing 30 may improve the formability for integrally molding the insulator 52 and the connector housing 30.

### (Modification)

(1) In the cover member 14 according to the present embodiment, the eight radial ribs 98 and the eight first adhesive reservoirs 100 are provided between the inner annular rib 99 and the cover-member side fixing surface 72; however, the number, size, and position of the radial ribs 98 may be changed as appropriate. For example, it is possible to provide only the four radial ribs 98 passing through the circumferential intermediate position between the gate marks 102 that are adjacent in the circumferential direction. Further, the number, size, and position of the first adhesive reservoirs 100 may be also changed as appropriate. Moreover, at least an embodiment of the present invention is also applicable to the case where the number of the gate marks 102 is not four.
(2) The cover member 14 and the resin sealing member 13 according to the present embodiment include the rotational engagement structure using the engagement projection 85 and the rotational engagement part 86 (the first rotational engagement part 86A, the second rotational engagement part 86B); however, such a rotational engagement structure may not be provided. When the rotational engagement structure is not provided, the lower annular cylindrical section 92e of the cover-member cylindrical part 92 may cover the outer peripheral surface of the resin sealing member 13 in all circumferences. Accordingly, as the part with a thin BMC-resin coating layer may be covered with the lower annular cylindrical section 92e, the insulating effect may be enhanced. Also, the waterproof effect may be improved.
(3) For the cover member 14 and the resin sealing member 13 according to the present embodiment, the rotational engagement structure is formed by providing the engagement projection 85 on the resin sealing member 13 and providing the rotational engagement part 86 on the cover member 14; however, it is also possible to adopt an embodiment in which an engagement projection is provided on the cover member 14 and a rotational engagement part is provided on the resin sealing member.

While the description above refers to particular embodiments of the present invention, it will be understood that many modifications may be made without departing from the spirit thereof. The accompanying claims are intended to cover such modifications as would fall within the true scope and spirit of the present invention.

Presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A motor comprising:
a rotor;
a stator disposed on an outer peripheral side of the rotor; and
a resin sealing member covering the stator, wherein
the stator comprises:
a stator core;
a coil wound around the stator core; and
a connector disposed on an outer peripheral side of the stator core;
the resin sealing member comprises a connector sealing part protruding to the outer peripheral side of the stator core and covering the connector; and
the connector comprises a connection opening through which an external connector is attached and detached, and the connection opening protrudes in an axial direction of the rotor from the connector sealing part and is opened in the direction of the axis.

2. The motor according to claim 1, wherein
the resin sealing member comprises a sealing member bottom part covering the stator core and the coil from an axial direction side,
the connector sealing part protrudes to a first side in the axial direction from the sealing member bottom part, and
a height, in the axial direction, of the connection opening from the sealing member bottom part is larger than a height of protrusion of the connector sealing part from the sealing member bottom part.

3. The motor according to claim 1, comprising a cover member disposed on a first side of the resin sealing member in the axial direction, wherein
the connector comprises a connector housing protruding from the connector sealing part to a second side in the axial direction, the connection opening being provided in the connector housing, and
one of the resin sealing member and the cover member comprises an engagement projection that protrudes toward an other of the resin sealing member and the cover member, and the other of the resin sealing member and the cover member comprises a rotational engagement part that is engaged with the engagement projection when the cover member is rotated relative to the resin sealing member around the axis.

4. The motor according to claim 3, wherein the connector comprises a terminal pin that is pressed and fitted into the connector housing.

5. The motor according to claim 4, wherein
the terminal pin comprises:
a terminal connection part pressed and fitted into the connector housing and protruding toward the connection opening;
a coupling part extending in a direction intersecting a direction in which the terminal connection part is pressed and fitted; and
a conductive-wire connection part connected to the terminal connection part via the coupling part, and
a holding groove structured to hold the coupling part is formed on an outer side surface of the connector housing.

6. The motor according to claim 5, wherein
the connector housing comprises a bottom part provided on an opposite side of the connection opening in the axial direction, and
a recess depressed in the axial direction is formed in the bottom part.

7. A pump apparatus comprising:
a motor comprising:
a rotor;
a stator disposed on an outer peripheral side of the rotor;
a resin sealing member covering the stator; and
a cover member disposed on one side of the resin sealing member in the direction of the axis;
wherein the stator comprises:
a stator core;
a coil wound around the stator core; and
a connector disposed on an outer peripheral side of the stator core;
the resin sealing member comprises a connector sealing part protruding to the outer peripheral side of the stator core and covering the connector; and
the connector comprises a connection opening through which an external connector is attached and detached, and the connection opening protrudes in an axial direction of the rotor from the connector sealing part and is opened in the direction of the axis;
an impeller attached to a rotary shaft of the rotor penetrating the cover member and protruding to the first side of the cover member in the axial direction;
the connector includes a connector housing protruding from the connector sealing part to other side in the direction of the axis, the connection opening being provided in the connector housing; and
one of the resin sealing member and the cover member is provided with an engagement projection that protrudes toward the other one thereof, and the other one is provided with a rotational engagement part that is engaged with the engagement projection when the cover member is rotated relative to the resin sealing member around the axis.

8. The motor according to claim 6, wherein
the resin sealing member comprises a sealing member bottom part covering the stator core and the coil from an axial direction side,
the connector sealing part protrudes in the axial direction from the sealing member bottom part, and
a height, in the axial direct, of the connection opening from the sealing member bottom part is larger than a height of protrusion of the connector sealing part from the sealing member bottom part.

9. The motor according to claim 3, wherein
the connector housing comprises a bottom part provided on an opposite side of the connection opening in the axial direction, and
a recess depressed in the axial direction is formed in the bottom part.
